(19) United States
(12) Patent Application Publication
(10) Pub. No.: US 2015/0009131 A1
(43) Pub. Date: Jan. 8, 2015

(54) System for Determining Three-Dimensional Position of Transmission Device Relative to Detecting Device

(71) Applicant: Jeenon, LLC, Santa Clara, CA (US)

(72) Inventors: Dongge Li, Xi'an (CN); Wei Wang, Xi'an (CN)

(21) Appl. No.: 14/371,424

(22) PCT Filed: Jan. 9, 2013
(86) PCT No.: PCT/CN2013/070286

§ 371 Date: Jul. 9, 2014

(30) Foreign Application Priority Data
Jan. 9, 2012 (CN) 2012100014619.0

(51) Int. Cl. G06F 3/03; G06F 3/00

(52) U.S. Cl. CPC G06F 3/0304; G06F 3/005
USPC 345/156

(57) ABSTRACT

An objective of the present invention is to provide a system for determining a three-dimensional location of an emitting apparatus with respect to a detecting apparatus. The system comprising: an emitting apparatus comprising a light-emitting source for sending a control signal and an optical unit for facilitating transmitting the control signal; a detecting apparatus comprising a camera, for obtaining imaging information of the control signal in the camera via the optical unit; a computing apparatus for determining three-dimensional location information of the emitting apparatus with respect to the detecting apparatus according to the imaging information. Compared with the prior art, the present invention, through providing in the emitting apparatus an optical unit for facilitating transmitting the control signal, realizes determining the three-dimensional location of the emitting apparatus with respect to the detecting apparatus, which not only reduces the configuration costs and lowers the energy consumption level, but also makes three-dimensional location information-based control feasible, thereby further enhancing control efficiency and improving user manipulation experience.

### FIELD OF THE INVENTION

The present invention relates to the technical field of intelligent control, and more specifically, relates to a technology of determining a three-dimensional location of an emitting apparatus with respect to a detecting apparatus.

### BACKGROUND OF THE INVENTION

In the field of intelligent control such as smart TV, motion sensing interaction, and virtual reality, etc., corresponding control operations, such as turning on or off a controlled device, are usually performed through detecting, by a detecting apparatus, certain signals emitted by an emitting apparatus, for example, an optical signal emitted by an LED (Light Emitting Diode), wherein the location information, particular the location information of the emitting apparatus with respect to the detecting apparatus, is very significant in aspects of improving control precision and simplifying control operations. For example, a mouse application is simulated through location variation of the emitting apparatus, so as to enhance the interactive capability between a user and a controlled device and improve the user's manipulation experience.

However, in the prior art, only a two-dimensional location can be determined; or a more complex emitting apparatus or detecting apparatus, for example, an emitting apparatus comprising a plurality of emitting sources or a detecting apparatus comprising a plurality of detecting spots, is required to possibly implement determination of a three-dimensional location. In the former case, it always has drawbacks such as insufficient control precision due to insufficient location information dimensions. In the latter case, although it supports control based on three-dimensional location information, it has drawbacks such as high configuration costs and high energy consumption, etc.

Thus, it is one of the imminent problems for those skilled in the art to solve how to determine a three-dimensional location of an emitting apparatus with respect to a detecting apparatus in view of the above drawbacks.

### SUMMARY OF THE INVENTION

An objective of the present invention is to provide a system for determining a three-dimensional location of an emitting apparatus with respect to a detecting apparatus.

According to one aspect of the present invention, there is provided a system for determining a three-dimensional location of an emitting apparatus with respect to a detecting apparatus, comprising:

an emitting apparatus comprising a light-emitting source for sending a control signal and an optical unit for facilitating transmitting the control signal;

a detecting apparatus comprising a camera, for obtaining imaging information of the control signal in the camera via the optical unit;

a computing apparatus for determining three-dimensional location information of the emitting apparatus with respect to the detecting apparatus according to the imaging information.

According to one aspect of the present invention, there is provided a preferred embodiment of a system for determining a three-dimensional location of an emitting apparatus with respect to a detecting apparatus, wherein the computing apparatus comprises:

an input determining unit for performing image recognition processing to the imaging information so as to obtain an input light domain corresponding to the imaging information;

a feature extracting unit for extracting light domain feature information of the input light domain;

a location determining unit for determining the three-dimensional location information according to a mapping relationship between a light domain feature as actually measured and three-dimensional location information based on the light domain feature information.

Preferably, the light domain feature information comprises at least one of the following items:
long axis information of the input light domain;
short axis information of the input light domain;
ratio information between a long axis and a short axis of the input light domain.

Preferably, the feature extracting unit is for extracting light domain feature information of the input light domain, wherein the light domain feature information comprises light domain-related information between the input light domains.

Preferably, the light domain-related information comprises at least one of the following items:
direction information of a connection line between centers of the input light domains;
distance information between the input light domains.

Preferably, the three-dimensional location information comprises three-dimensional translational location information of the emitting apparatus with respect to the detecting apparatus;

wherein the location determining unit is configured to:
determine the three-dimensional translational location information based on the light domain feature information according to a mapping relationship between a light domain feature as actually measured and a distance of the emitting apparatus with respect to the detecting apparatus.

Preferably, the three-dimensional location information comprises three-dimensional rotational location information of the emitting apparatus with respect to the detecting apparatus;

wherein the location determining unit is configured to:
determine the three-dimensional rotational location information according to a mapping relationship between a light domain feature as actually measured and an included angle of the emitting apparatus with respect to the detecting apparatus based on the light domain feature information.

Preferably, the computing apparatus further comprises a noise cancelation unit configured to:
perform group processing according to a light emitting mode of the input light domains and/or distances between each two of the input light domains, so as to obtain one or more light domain sets, wherein each light domain set comprises one or more input light domains;
select a preferable light domain set from the one or more light domain sets according to set feature information of the light domain sets to act as a processing object of the feature extracting unit.

According to one aspect of the present invention, there is provided another preferred embodiment of a system for determining a three-dimensional location of an emitting apparatus with respect to a detecting apparatus, wherein the system further comprising:

a location adjusting apparatus for adjusting the three-dimensional location information according to location reference information of the three-dimensional location information so as to obtain the adjusted three-dimensional location information.

Preferably, the location adjusting apparatus is for adjusting the three-dimensional location information according to location reference information of the three-dimensional location information so as to obtain the adjusted three-dimensional location information, wherein the location reference information comprises historical location information corresponding to the three-dimensional location information.

Preferably, the location adjusting apparatus is for adjusting the three-dimensional location information according to location reference information of the three-dimensional location information so as to obtain the adjusted three-dimensional location information, wherein the location reference information comprises three-dimensional location information in a frame relevant to the frame where the imaging information is located corresponding to the three-dimensional location information.

Preferably, the system further comprises:

a location predicting apparatus for predicting predicted three-dimensional location information of the emitting apparatus with respect to the detecting apparatus according to historical three-dimensional location information of the emitting apparatus with respect to the detecting apparatus in combination with a predetermined motion model;

wherein the location adjusting apparatus is for adjusting the three-dimensional location information according to location reference information comprising the predicted three-dimensional location information so as to obtain the adjusted three-dimensional location information.

According to one aspect of the present invention, there is provided another preferred embodiment of a system for determining a three-dimensional location of an emitting apparatus with respect to a detecting apparatus, wherein the optical unit comprises at least one of the following items:
a reflector disposed at a side face or rear end of the light-emitting source;
a light transmission body disposed at a front end of the light-emitting source.

Preferably, the reflector has a convex reflecting face.

Preferably, the light transmission body is inwardly concave towards the light-emitting source to form a flute.

Preferably, the emitting apparatus comprises a plurality of light-emitting sources, at least one of the plurality of light-emitting sources is configured with at least one of the optical unit.

According to another aspect of the present invention, there is provided a system for remotely controlling a controlled device, wherein the system comprises:

an emitting apparatus comprising a light-emitting source for sending a control signal and an optical unit for facilitating transmitting the control signal;

a detecting apparatus comprising a camera, for obtaining imaging information of the control signal in the camera via the optical unit;

a computing apparatus for determining three-dimensional location information of the emitting apparatus with respect to the detecting apparatus based on the imaging information;

a control apparatus for determining a control instruction corresponding to the three-dimensional location information so as to control a controlled device connected to the system.

Compared with the prior art, the present invention, through providing in the emitting apparatus an optical unit for facilitating transmitting the control signal, realizes determining the three-dimensional location of the emitting apparatus with respect to the detecting apparatus, which not only reduces the configuration costs and lowers the energy consumption level, but also makes three-dimensional location information-based control feasible, thereby further enhancing control efficiency and improving user manipulation experience. Further, the present invention may also be used to determine a three-dimensional translational location or three-dimensional rotational location of an emitting apparatus with respect to a detecting apparatus. Moreover, the present invention may also predict current three-dimensional location information from corresponding historical three-dimensional location information in combination with a motion model, to adjust the actual three-dimensional location information as detected, thereby obtaining more accurate three-dimensional location information. Besides, the present invention may also be directly applied to remotely control a controlled device, such that not only the control efficiency is improved, but also the user manipulation experience is enhanced.

### BRIEF DESCRIPTION OF THE SEVERAL VIEWS OF THE DRAWINGS

Through reading the following detailed depiction on the non-limiting embodiments with reference to the accompanying drawings, the other features, objectives, and advantages of the present invention will become more apparent.

FIG. 1 illustrates a schematic diagram of a system for determining a three-dimensional location of an emitting apparatus with respect to a detecting apparatus according to one aspect of the present invention;

FIG. 2 illustrates a schematic diagram of a computing apparatus according to one preferred embodiment of the present invention;

FIG. 3 illustrates a schematic diagram of a system for determining a three-dimensional location of an emitting apparatus with respect to a detecting apparatus according to another preferred embodiment of the present invention;

FIG. 4a and FIG. 4b illustrate a schematic diagram of an optical unit according to a further preferred embodiment of the present invention, respectively;

FIG. 5 illustrates a schematic diagram of a system for remotely controlling a controlled device according to another aspect of the present invention.

Same or like reference numerals in the accompanying drawings indicate the same or corresponding components.

### DETAILED DESCRIPTION OF THE INVENTION

Hereinafter, the present invention will be further described in detail with reference to the accompanying drawings.

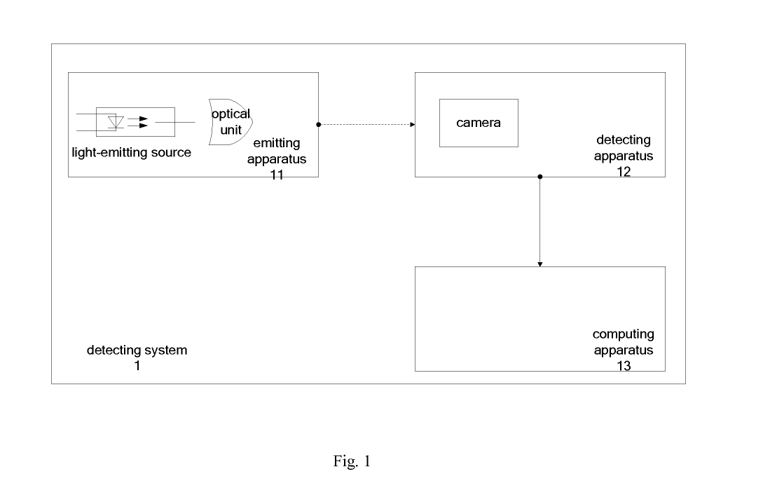

FIG. 1 illustrates a schematic diagram of a system for determining a three-dimensional location of an emitting apparatus with respect to a detecting apparatus, wherein a detecting system 1 comprises an emitting apparatus 11, a detecting apparatus 12, and a computing apparatus 13.

The emitting apparatus 11 comprises a light-emitting source for sending a control signal and an optical unit for facilitating transmitting the control signal. For example, in the emitting apparatus 11, the light-emitting source is provided at a rear end of the optical unit. A control signal emitting emitted by the light-emitting source is transmitted through the optical unit so as to be available for the detecting apparatus 12 to obtain imaging information of the control signal through a camera provided in the detecting apparatus 12. Or, the optical unit is provided in a rear end of the light-emitting source. The optical unit reflects a control signal emitted by the light-emitting source to a camera in the detecting apparatus 12 to be available to detect imaging information of the control signal in the camera via the optical unit. Preferably, for the control signal emitted from the light-emitting source, through transmission of a plurality of cooperating optical units, its imaging information in a camera of the detecting apparatus 12 is detected by the camera of the detecting apparatus 12.

Here, the light-emitting source includes, but not limited, to a spot light source, a plane light source, a ball light source, or any other light source that emits light at a certain light emitting frequency, for example, an LED visible light source, an LED infrared light source, an OLED (Organic Light-Emitting Diode) light source, and a laser light source, etc. Here, the LED (Light Emitting Diode) is a solid semiconductor device capable of converting electrical energy into visible light. It may directly converts electricity into light and takes the light as a control signal. The following embodiments will use the light-emitting source or LED in alternation. Those skilled in the art should understand that other existing light-emitting sources or those possibly evolved in the future, particularly for example an OLED, if applicable to the present invention, should also be included within the protection scope of the present invention, which are incorporated here by reference.

Here, the optical unit includes, but not limited to: 1) a reflector disposed at a rear end or side face of the light-emitting source; 2) a light transmission body disposed at a front end of the light-emitting source. Preferably, the reflector has an concave or convex reflecting face. For example, the detecting apparatus 12 may obtain other imaging information of the control signal through the reflector disposed at a side face of the light-emitting source and having a convex reflecting face. Preferably, the light transmission body has a flute whose opening direction is identical or reverse to the control signal propagation direction of the light-emitting source.

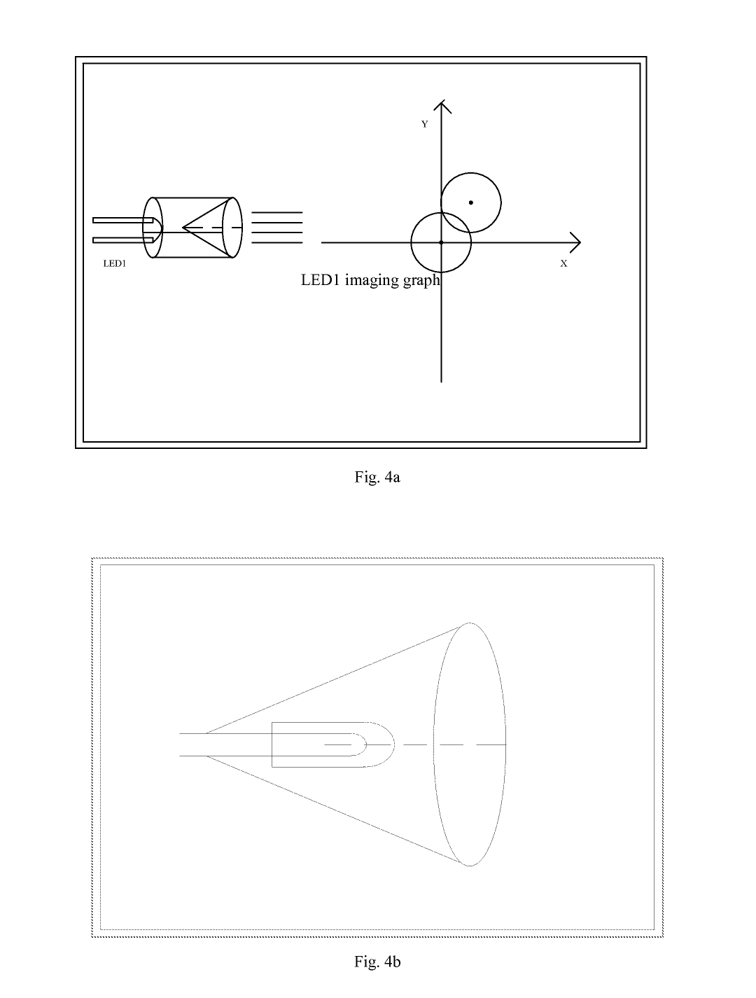

As illustrated in FIG. 4a, in the emitting apparatus 11, the optical unit preferably includes a light transmission body disposed at a front end of the light-emitting source, wherein the light transmission body is recessed towards the light-emitting source to form a conical concavity. The longitudinal section of the conical concavity may be of a straight line type, an arc type or an irregular type, so as to obtain different imaging information of the control signal in the camera.

As illustrated in FIG. 4b, in the emitting apparatus 11, the optical unit preferably includes a concave reflector disposed at a rear end of the light-emitting source, wherein the light-emitting source is disposed in an opening of the concave reflector, the concavity of the concave reflector is of a conical shape. The longitudinal section of the conical concavity may be of a straight line type, an arc type or an irregular type, so as to obtain different imaging information of the control signal in the camera.

Preferably, the emitting apparatus 11 comprises a plurality of light-emitting sources, wherein at least one light-emitting source is configured with at least one optical unit. For example, the emitting apparatus 11 comprises N light-emitting sources, wherein some light-emitting sources are configured with different numbers and types of optical units, and some light-emitting sources are not configured with optical units.

The detecting apparatus 12 comprises a camera for obtaining imaging information of the control signal in the camera through the optical unit, so as to be available for the computing apparatus 13 to determine the three-dimensional location information of the emitting apparatus with respect to the detecting apparatus.

The computing apparatus 13 obtains the three-dimensional location information of the emitting apparatus with respect to the detecting apparatus according to the imaging information obtained by the detecting apparatus through for example querying a predetermined location curve or through performing interpolation processing on the location information obtained by table look-up.

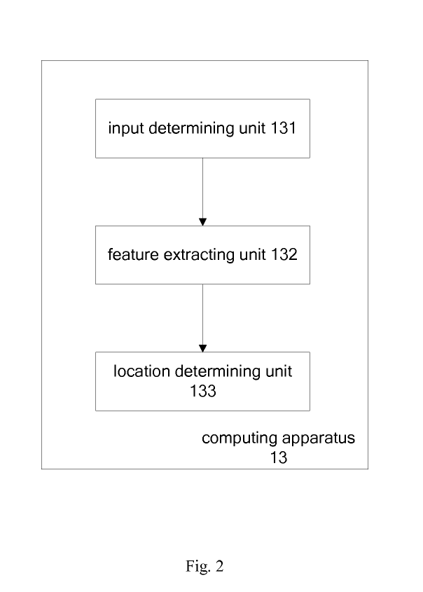

As illustrated in FIG. 2, the computing apparatus 13 comprises an input determining unit 131, a feature extracting unit 132, and a location determining unit 133. Here, the input determining unit 131 performs image identification processing to the imaging information so as to obtain an input light domain corresponding to the imaging information; the feature extracting unit 132 extracts light domain feature information of the input light domain; and the location determining unit 133 determines the three-dimensional location information according to a mapping relationship between a light domain feature as actually measured and three-dimensional location information based on the light domain feature information.

Specifically, the input determining unit 131 processes the imaging information provided by the detecting apparatus 12 through image recognition algorithms such as binarization, Hough transformation, or threshold filtering for light spots, etc., so as to obtain an input light domain corresponding to the imaging information. Here, the input light domain refers to an optical region distinct from its surrounding region in the imaging information; generally, the input light domain comprises an optical region directly formed in the camera by a control signal transmitted by the light-emitting source, an optical region formed by the control signal in the emitted by the light-emitting source, an optical region formed in the camera through reflection and/or transmission via the optical unit by the control signal, or any combination of the two. For example, the input determining unit 131 performs binarization processing to each pixel in the imaging information through a preset threshold value to obtain a corresponding binarization image; performs Hough transformation to the border formed by the binarization image to obtain one or more optical regions existing in the binarization image to act as the input light domain. Preferably, the input determining unit 131 may further perform screening processing to the one or more optical regions as obtained previously, for example, through preset scopes of feature parameters, for example, a scope of pixel amounts, a scope of radius size, and a scope of ratio between long and short axes, excluding ineligible optical regions to obtain an input light domain corresponding to the imaging information. For example, suppose input light domains are approximate to round, then only the input light domain having a radius falling within a predetermined valid radius scope can be regarded as a valid input light domain. If there are a plurality of eligible input light domains, the brightest one or more input light domains may be selected as the input light domains.

Those skilled in the art should understand that the input light domain as obtained here is one or more adjacent or overlapping approximately round shapes, oval shapes or other regular or approximately regular images. The above image processing algorithm is only an example. Other existing image processing algorithms or those possibly evolved in the future, if applicable to the present invention, should be included within the protection scope of the present invention, which are incorporated here by reference.

The feature extracting unit 132 performs imaging processing to the input light domain as obtained by the input determining unit 131 through Hough transformation, primary component analysis (PCA) or independent component analysis (ICA), etc., to extract light domain feature information of the input light domain. For example, when the light-emitting source emits light with certain brightness (here, the brightness indicates the light flux of the light-emitting source in a unit solid angle unit area in a specific direction), the feature extracting unit 132 determines brightness information corresponding to the input region(s) for example through computing an average value or sum of the gray values of the input light domain. For another example, for an input light domain obtained by the input determining unit 131, the feature extracting unit 132 performs principal axis transformation through PCA approach to calculate the location, size and direction of an axis whose regional distribution is most discrete, to act as the location, length and direction of the long axis. For another example, for an input light domain obtained by the input determining unit 131, the feature extracting unit 132, through calculating distances between two pixels in the input light domain, determines a connection line between two pixels with the farthest distance as the long axis of the input light domain, and the corresponding distance being the length of the long axis. According to the above example, the feature extracting unit 132 may also take the included angle between the long axis and the horizontal axis or vertical axis of the imaging information to which the input light domain belongs as the direction information of the long axis. Similarly, the feature extracting unit 132 may determine short axis information of an input light domain. Here, calculating a distance between two pixel points may adopt Euclidean distance or Mahalanobis distance. Those skilled in the art should understand that the above method of obtaining light domain feature information is only exemplary, and other existing methods of obtaining light domain feature information or those possibly evolved in the future, if applicable to the present invention, should also be included within the protection scope of the present invention, which are incorporated here by reference.

Here, the light domain feature information comprises at least one of the following items:
long axis information of the input light domain, for example, location, length, and direction information of the long axis;
short axis information of the input light domain, for example, location, length, and direction information of the short axis;
ratio information between a long axis and a short axis of the input light domain.

Those skilled in the art should understand that the above light domain feature information is only exemplary, and other existing light domain feature information or the information possibly evolved in the future, if applicable to the present invention, should also be included within the protection scope of the present invention, which is incorporated here by reference.

Preferably, the feature extracting unit extracts the light domain feature information of the input light domain, wherein the light domain feature information comprises light domain-related information between the input light domains. Specifically, the feature extracting unit 132 extracts the light domain feature information of the input light domain through performing clustering or splitting processing to the input light domain, wherein the light domain feature information comprises light domain-related information between the input light domains, for example, the direction information of the connection line between the centers of the input light domains, the distance information between the input light domains, or a combination thereof.

For example, the feature extracting unit 132 obtains one or more input light domain sets through performing clustering processing to the input light domains according to the distance between each two input light domains, wherein each input light domain set comprises one or more input light domains; and then it determines light domain-related information between the input light domains, for example, the direction information of the connection lines between the centers of the input light domains, the distance information between the input light domains, or a combination of the two, based on for example, randomly selected or preferable input light domains in the input light domain set, such as location information of these input light domains in the imaging information. Preferably, the feature extracting unit 132 may also determine the distance between the two input light domain sets or the direction of the connection line between the two centers, to act as the distance information between the input light domains or the direction information of the connection line between the centers.

For another example, the feature extracting unit 132 detects whether an input light domain satisfies a condition for splitting through the shape of the input light domain or the ratio between its long axis and short axis, for example, determining whether it includes an overlapping input light domain based on the shape of the input light domain, or detecting whether the ratio between the long axis and short axis of the input light domain exceeds a predetermined threshold; when the condition(s) is satisfied, the input light domain is subjected to the splitting processing, for example, performing splitting at the overlapping location of the input light domain or the location where its short axis is located, so as to obtain two or more input light domains, and determine a distance between the split input light domains or the direction of the connection line between their centers to act as the distance information between the input light domains or the direction information of the connection line between the centers.

Those skilled in the art should understand that the above light domain-related information and its extracting manner are only exemplary, and other existing light domain-related information and its extracting manner or the light domain-related information and its extracting manner possibly evolved in the future, if applicable to the present invention, should also be included within the protection scope of the present invention, which are incorporated here by reference.

The location determining unit 133 determines the three-dimensional location information according to a mapping relationship between the actually measured light domain feature and three-dimensional location information based on the light domain feature information. For example, the location determining unit 133 directly determines the three-dimensional location information corresponding to the light domain feature information according to the mapping relationship (for example, mapping curve or data table) between the actually measured light domain feature information (for example, brightness) of an input light domain and the distance of the emitting apparatus with respect to the detecting apparatus; or, obtains a plurality of pieces of candidate three-dimensional location information which are relatively relevant to the light domain feature information, and then performs interpolation processing to the plurality of pieces of candidate three-dimensional location information, thereby determining the three-dimensional location information corresponding to the light domain feature information. Here, the mapping relationship is stored in the detection system or a third-party device such as a location server connected to the detection system over a network; the mapping relationship may be established through measured values of the light domain feature information under different three-dimensional locations; the shorter the step of the three-dimensional location in the actual measurement, the more accurate is the three-dimensional location information obtained from the mapping relationship. The mapping relationship may be ordered based on the light domain feature information or stored through Hash processing, so as to improve the search or query efficiency.

Here, the image center-based two-dimensional coordinate of the center of an input light domain, for example the intersection between its long axis and short axis, in the imaging information is denoted as (x, y), Wherein x is the horizontal coordinate of the center of the input light domain in the image, and y is the longitudinal coordinate of the center of the input light domain in the image.

Here, the three-dimensional coordinate of a spatial origin is marked as (X0, Y0, Z0), then the three-dimensional translational location information of the emitting apparatus 11 is its three-dimensional coordinate (X, Y, Z), where X denotes the horizontal coordinate of the center of mass of the emitting apparatus 11, Y denotes the vertical coordinate of the center of mass of the emitting apparatus 11, and Z denotes the depth coordinate of the center of mass of the emitting apparatus 11. Through the equation X=x(λ−Z)/λ, Y=y(λ−Z) /λ, the three-dimensional location information (X, Y, Z) of the emitting apparatus 11 is calculated based on the two-dimensional circle center coordinate (x, y) of the emitting apparatus 11, wherein λ is a focal distance of the camera. The specific calculation manner for the distance information Z of the emitting apparatus 11 with respect to the detecting apparatus 12 will be described in detail subsequently.

The three-dimensional rotational location information of the emitting apparatus 11 may be denoted as θ, wherein θ denotes an included angle between the axial line of the emitting apparatus 11 and a connection line between the emitting apparatus 11 to the detecting apparatus 12. Further, the three-dimensional rotational location information of the emitting apparatus 11 may be further denoted as (θ, γ), wherein γ denotes a rotating angle of the emitting apparatus 11 about its centroidal axis, i.e., self-rotating angle of the emitting apparatus 11. Besides, according to the previously mentioned included angle θ, with reference to the three-dimensional translational location information (X, Y, Z) of the emitting apparatus 11, the three-dimensional rotational location information of the emitting apparatus 11 may be further denoted as (α, β, γ), i.e., the spatial orientation of the emitting apparatus 11 through its centroidal axis, wherein a denotes a horizontal directional angle of the emitting apparatus 11 through its centroidal axis, while β denotes a vertical directional angle of the emitting apparatus 11 through its centroidal axis.

When the input light domain comprises a plurality of input light domains, the three-dimensional location information may be determined from at least the following two dimensions:

1) first, determining an input light domain for calculation in the input light domain, and then determining the three-dimensional location information of the emitting apparatus 11 based on the input light spot, wherein the input light spot for calculation may be all or some of the input light domains among the input light domains; the computing apparatus 13 may select any one input light domain of the input light domain set as the input light domain for calculation, and determine the three-dimensional location information of the emitting apparatus 11; it may also determine the three-dimensional location information of a corresponding spot based on a geometrical structure between the selected input light domains for calculation, for characterizing the three-dimensional location information of the emitting apparatus 11, for example, based on the gravity center of a geometry formed by the selected input light domains, taking the three-dimensional location information of the gravity center as the three-dimensional location information of the emitting apparatus 11.

2) first, obtaining three-dimensional location information of each input light domain among the input light domains, and then determining the three-dimensional location information of the emitting apparatus 11 through various kinds of calculation processing on the three-dimensional location information. Here, the calculation processing includes, but not limited, to various calculations applicable to the present invention performed to three-dimensional location information of each input light domain among the input light domains, for example, averaging the three-dimensional location information of all the input light domains, calculation of the three-dimensional location information of various kinds of gravity centers or apexes based on the geometrical structure between a plurality of input light domains, etc.

Preferably, the three-dimensional location information includes the three-dimensional translational location information of the emitting apparatus with respect to the detecting apparatus, wherein the location determining unit 133 determines the three-dimensional translational location information according to a mapping relationship between the light domain feature as actually measured and a distance of the emitting apparatus with respect to the detecting apparatus based on the light domain feature information.

For example, suppose the input light domain is round, after the input light domain of the light-emitting source is determined, the location determining unit 133 determines the distance Z of the emitting apparatus 11 with respect to the detecting apparatus 12 based on the predetermined distance fitting curve Z=f(1/r,I) according to the light spot circle radius r and brightness I of the input light spot, and calculates the three-dimensional translational location information (X, Y, Z) of the light-emitting source with reference to the two-dimensional coordinate (x, y) of the circle center of the input light domain in the shot image through the equation X=x (λ−Z)/λ, Y=y (λ−Z) /λ.

Here, about determining the distance fitting curve, corresponding r and I may be measured for the distance Z, and it is required to measure enough samples for different distances Z according to a certain step, i.e., the values of r and I (or other available features), so as to fit the mapping relationship between r, I, and Z according to a minimum error criterion with a linear or quadratic (or multiple) curve. When sampling, an LED whose optical features may uniquely determine the distance Z through the combination of r and I within a valid working range should be selected.

To simplify the operation, when sampling, enough samples may be measured for different distances Z under different included angles θ according to a certain step, i.e., the values of r and I, and the corresponding fitting curves of the distance Z and included angle θ are determined, respectively.

Besides, the fitting curve of the distance Z may also be determined with reference to the light distribution feature of the input light spot and/or the light emitting mode of the light-emitting source 111, etc. Here, the light distribution feature of the input light spot comprises for example principal axis direction and size of feature transformation (PCA transformation) of the light distribution within the light spot. The light emitting mode added into the LED through a special process, for example, the center of the LED light source does not emit light (the corresponding input light spot is a black point at the center), the center of the LED light source emits a white light (the corresponding input light spot is a bright spot at the center), or the LED light source emits a light of different colors (frequencies), or making the input light spot of the LED light source as captured by the camera is in an oval shape, not generally a round shape, etc., may help to detect the three-dimensional location information of the emitting apparatus 11.

For example, Z=g(r, I, t1, t2), wherein t1, t2 are variables for describing the light distribution feature within the input light domain. Because there are more variables that reflect the three-dimensional location, this method has a wider application for LED, and it is more accurate in detecting the three-dimensional location of LED.

Or, here, enough sample values of r, I and Z are acquired and stored according to a certain distance interval so as to establish a light domain feature information-distance sample table. For a group of to-be-queried r and I, if the sample table does not contain corresponding record yet, one or more groups of r and I samples in the sample table which are nearest to the to-be-queried r and I in distance may be calculated, and through performing interpolation calculation to one or more corresponding Z samples, the distance Z of the emitting apparatus 11 with respect to the detecting apparatus 12 is obtained, wherein the interpolation algorithms include, but not limited, to any existing interpolation algorithms or those interpolation algorithms possibly evolved in the future, as long as they are suitable for the present invention, such as nearest neighbor interpolation, linear weight interpolation, and bicubic interpolation, etc.

Those skilled in the art should understand that the above manner of obtaining the three-dimensional translational location information of the emitting apparatus 11 using a round input light domain is only an example, and for an input light domain of oval or other shape, a similar manner may be adopted using information such as its long and short axis information and the distance between input light domains, to determine the three-dimensional translational location information of the emitting apparatus 11, which will not be detailed here, but incorporated hereby by reference.

Preferably, the three-dimensional location information comprises the three-dimensional rotational location information of the emitting apparatus with respect to the detecting apparatus, wherein the location determining unit 133 determines the three-dimensional rotational location information according to a mapping relationship between the light domain feature as actually measured and the included angle of the emitting apparatus with respect to the detecting apparatus based on the light domain feature information.

Here, in order to determine the mapping relationship between the light domain feature and the included angle, for example, the fitting curve or lookup table of the two, the corresponding r and I may be measured for the included angle θ, and it is required to measure enough samples under different included angles θ according to a certain step, i.e., values of r and I (or other available features); and the mapping relationship among r, I, and θ is fitted according to a minimum error criterion with a linear or quadratic (or multiple) curve. When sampling, a light-emitting source whose optical features may uniquely determine the included angle θ through the combination of r and I within a valid working range should be selected, for example LED.

Besides, the fitting curve of the included angle θ may also be determined with reference to the light distribution feature of the input light domain and/or the light emitting mode of the light-emitting source, etc. Here, the light distribution feature of the input light domain comprises for example principal axis direction and size of feature transformation (PCA transformation) of the light distribution within the light domain. The light emitting mode, for example, the center of the LED does not emit light (black spot), emits a white light (bright spot), or emits light of different colors (frequencies), or the light spot of an oval shape of the LED is not a general round light spot, etc., through a special light emitting mode added to the LED in a special process, may help to detect the three-dimensional location information of the light-emitting source 111.

For example, through detecting the direction of the oval, the self included angle γ of the LED may be obtained, and the direction of the oval is the principal axis direction of the feature transformation of the oval distribution. Through detecting the location of the central black spot or bright spot of the input light domain, the deflection direction and size of the included angle θ may be detected, and the black spot or bright spot is the darkest or brightest central location in the light spot. The deflection direction of the included angle θ is the direction from the center of the input light spot to the black spot or bright spot center. Deflection directions, sizes, and locations of different included angles θ, the distance d from the corresponding light spot center to the black spot or bright spot center, and the gradient size k of the brightness variation of the input light domain in the deflection direction are detected; θ=h(d, k). Because k may also be associated with the distance Z, θ=h(d, k, Z); or in more complex circumstance, θ=h(d, k, X, Y, Z); correspondingly, at this time, it is required to measure enough samples (i.e., the values of d and k) for different X, Y, Z under different θ according to a certain step.

Particularly, by using an optical unit whose reflection face is concave, the detection apparatus 12 may generate different input regions (for example, a reflecting origin or making the LED origin become an oval) within a valid working scope when the LED is biased from the camera; the feature extracting unit 132 determines the three-dimensional location information based on these input light domains, for example, based on the location of the reflecting origin and the distance between itself and the LED light spot, the deflection direction and size of θ may be mapped out or sample interpolated out. Specifically, the LED light spot is the origin with highest brightness, and the origin of its neighboring domain is a reflecting spot. The direction of the connection line from the LED light spot to the center of the reflecting spot is the deflecting direction of θ. By using the length of the connecting line, the size of θ may be calculated through the above curve mapping or sample interpolation manner. When θ is relatively smaller or larger with respect to some reflecting faces, the round spot in a neighboring domain of the light-emitting spot and the light-emitting spot may be connected together to form an oval or rectangular light spot. The deflecting direction and size of θ may be calculated through curve mapping or sample interpolation manner through detecting the principal axis direction and length (size) of the oval or rectangular shape using a method similar to the above obtaining the three-dimensional location by detecting a special mode. Once the deflecting direction and size of θ are obtained, α, β may be uniquely determined based on the three-dimensional translational location of the emitting apparatus 11, thereby obtaining the three-dimensional rotational location of the emitting apparatus 11.

Preferably, the computing apparatus further comprises a noise cancellation unit (not shown) which performs group processing to the input light domain based on the light emitting mode of the input light domain and/or the distance between each two input light domains, so as to obtain one or more light domain sets, wherein each light domain set comprises one or more input light domains; a preferred light domain set is selected from the one or more light domain sets based on the set feature information of the light domain sets to act as the processing object of the feature extracting unit.

For example, the noise cancellation unit classifies a plurality of input light domains based on the light emitting mode to obtain light domain sets corresponding to different shapes, respectively; then based on the light emitting modes of these light domain sets, a preferred light domain set is selected therefrom, for example, a light domain set corresponding to a particular shape, to act as the processing object of the feature extracting unit. For another example, the noise cancellation unit performs clustering processing to the input light domain based on the distance between each two input light domains so as to obtain one or more light domain cluster sets, wherein each light domain cluster set comprises one or more input light domains; based on the set feature information of the light domain cluster sets, a preferred light domain cluster set is selected from the one or more light domain cluster sets to act as the processing object of the feature extracting unit.

For example, the noise cancellation unit first clusters input light domains whose locations are near into sets, and then extracts feature information of each set, for example, color (wavelength) components, brightness components, flickering frequency, light emitting mode, geometrical information, etc., and based on such feature information, filters off corresponding set features (for example, color (wavelength) components, brightness components, flickering frequency, light emitting mode, geometrical information, etc.) that do not conform to a predetermined light-emitting source, such that the noise can be effectively cancelled, and the set conforming to the predetermined set features is taken as the input light spot. In order to effectively filter the noise, the set features corresponding to the light-emitting source may be obtained through actual measurement, for example, different colors, different brightness, different light emitting modes, different flickering frequencies, or any combination thereof.

Here, the light emitting mode comprises at least one of the following items:
predetermined shape;
predetermined wavelength;
predetermined flickering frequency;
predetermined brightness;
predetermined brightness distribution;
   For example, the LED emits light with a predetermined shape, for example, emitting light of a triangular, round, square or other shape; for example, the LED is manufactured into a special shape, and then the emitted light has the special shape as a control signal; or a plurality of LEDs form a triangular, round, or square, or other shape, and meanwhile emit light as a control signal; further or, each LED in the LED matrix forms a light emitting pattern with a special shape through switching on or off, as a control signal. For another example, the LED emits light with a predetermined wavelength to form a color corresponding to the predetermined wavelength. For another example, the LED emits light with a predetermined flickering frequency, for example, 10 times per second. Or, the LED emits light with a predetermined brightness. Here, brightness indicates the light flux of the LED in a unit solid angle unit area in a particular direction; the brightness may be indicated through calculating the average value or sum of the gray values of the LED in the imaging information corresponding to the LED frame. Further or, the LED emits light with a predetermined brightness distribution, for example, emitting light with a predetermined brightness distribution of bright in the circumference while dark in the center. More preferably, irrespective of the shape, wavelength (color), brightness or brightness distribution, the LED always sends the control signal with a predetermined flickering frequency, for example, 10 times per second.

Those skilled in the art should understand that the above light emitting modes are only exemplary, and other existing light emitting modes or those possibly evolved in the future, if applicable to the present invention, should also be included within the protection scope of the present invention, which are incorporated here by reference.

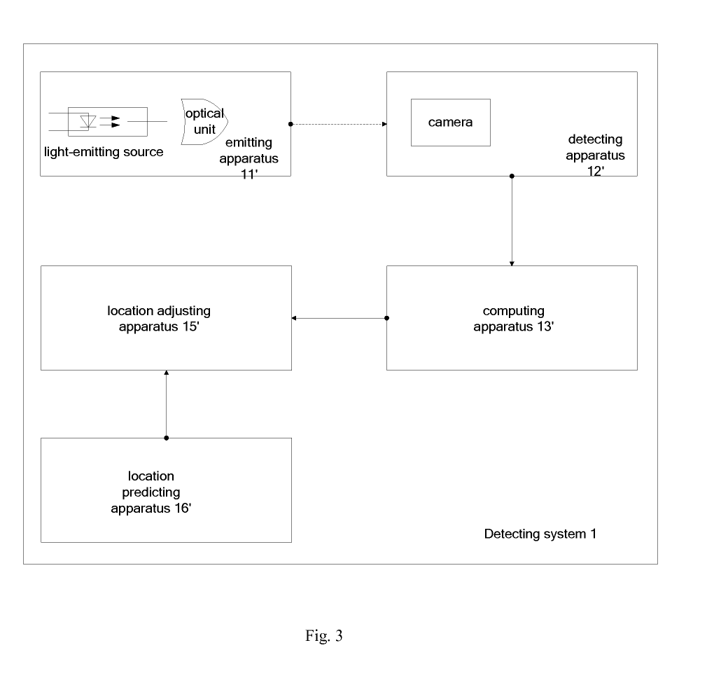

FIG. 3 illustrates a schematic diagram of a system for determining a three-dimensional location of an emitting apparatus with respect to a detecting apparatus according to another preferred embodiment of the present invention, wherein the system further comprises a location adjusting apparatus 15′. Specifically, the emitting apparatus 11′ comprises a light-emitting source for transmitting a control signal and an optical unit for facilitating transmission of the control signal; the detecting apparatus 12′ comprises a camera for obtaining imaging information of the control signal in the camera via the optical unit; the computing apparatus 13′ determines three-dimensional location information of the emitting apparatus with respect to the detecting apparatus based on the imaging information; location adjusting apparatus 15′ adjusts the three-dimensional location information based on location reference information of the three-dimensional location information so as to obtain the adjusted three-dimensional location information. The emitting apparatus 11′, detecting apparatus 12′, and computing apparatus 13′ are identical or substantially identical to the corresponding apparatuses in the previous embodiments, which will thus not be detailed here but incorporated here by reference.

Specifically, the location adjustment apparatus 15′ adjusts the three-dimensional location information based on the location reference information of the three-dimensional location information (for example, historical location information corresponding to the three-dimensional location information, three-dimensional location information in a frame relevant to the frame where the imaging information is located corresponding to the three-dimensional location information, or any combination thereof), through for example weighted average, or first selecting preferably several pieces of location information based on the concentration degree of the location information and then performing weighted average to them, thereby obtaining the adjusted three-dimensional location information.

For example, the location adjusting apparatus 15′ may adjust the three-dimensional location information through weighted averaging the historical location information of the three-dimensional location information, for example, the three-dimensional location information of the previous N1 times, so as to obtain the adjusted three-dimensional location information.

For another example, the location adjusting apparatus 15′ may adjust the three-dimensional location information through weighted averaging the three-dimensional location information in a frame relevant to the frame where the imaging information is located corresponding to the three-dimensional location information, for example, the corresponding three-dimensional location information in the preceding N2 frames or the corresponding three-dimensional location information in N3 frames obtained by other cameras in approximate times, thereby obtaining the adjusted three-dimensional location information.

Those skilled in the art should understand that the above manner of adjusting the three-dimensional location information is only exemplary, and other existing manners of adjusting the three-dimensional location information or those manners possibly evolved in the future, if applicable to the present invention, should also be included within the protection scope of the present invention, which are incorporated here by reference.

Preferably, the system further comprises a location predicting apparatus 16′. Specifically, the emitting apparatus 11′ comprises a light-emitting source for transmitting a control signal and an optical unit for facilitating transmission of the control signal; the detecting apparatus 12′ comprises a camera for obtaining imaging information of the control signal in the camera via the optical unit; the computing apparatus 13′ determines three-dimensional location information of the emitting apparatus with respect to the detecting apparatus based on the imaging information; location predicting apparatus 16′ predicts predicted three-dimensional location information of the emitting apparatus with respect to the detecting apparatus based on historical three-dimensional location information of the emitting apparatus with respect to the detecting apparatus in combination with a predetermined motion model; and the location adjusting apparatus 15′ adjusts the three-dimensional location information based on the location reference information comprising the predicted three-dimensional location information, to obtain the adjusted three-dimensional location information. The emitting apparatus 11′, detecting apparatus 12′, computing apparatus 13′, and location adjusting apparatus 15′ are identical or substantially identical to the corresponding apparatuses in the previous embodiments, which will thus not be detailed here but incorporated here by reference.

Specifically, the location predicting apparatus 16′ predicts the predicted three-dimensional location information of the emitting apparatus with respect to the detecting apparatus based on the historical three-dimensional location information of the emitting apparatus with respect to the detecting apparatus in combination with a predetermined motion model. Here, the predetermined motion model includes, but not limited to, even-rate model, acceleration model, etc. Here, the present embodiment may also adopt a more complex light spot motion tracking algorithm, for example, adopting a particle filter scheme, to detect the motion light spot in the plurality of consecutive imaging information.

Next, the location adjusting apparatus 15′ adjusts the three-dimensional location information based on the location reference information comprising the predicted three-dimensional location information, for example, taking the weighted average value of the two as the adjusted three-dimensional location information. Preferably, the present invention may also adjust the predetermined motion model based on the adjusted three-dimensional location information so as to obtain an updated motion model to be available for subsequently predicting the three-dimensional location information of the emitting apparatus with respect to the detecting apparatus.

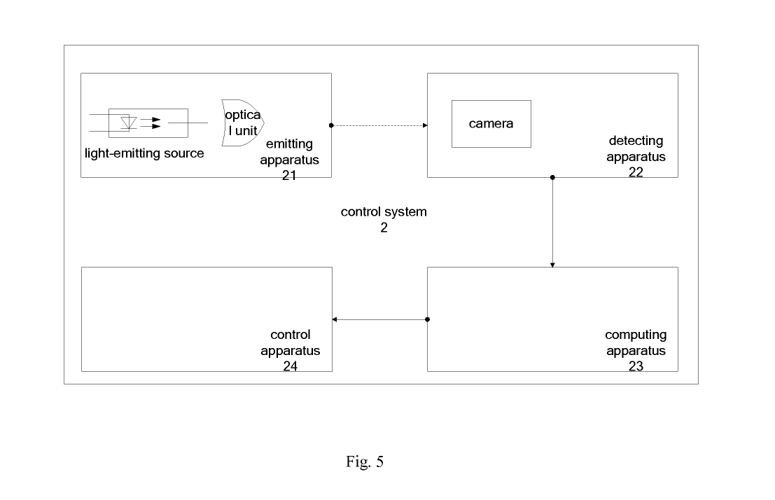

FIG. 5 illustrates a schematic diagram of a system for remotely controlling a controlled device according to another aspect of the present invention; wherein the control system 2 comprises an emitting apparatus 21, a detecting apparatus 22, a computing apparatus 23, and a control apparatus 24. Specifically, the emitting apparatus 21 comprises a light-emitting source for transmitting a control signal and an optical unit for facilitating transmission of the control signal; the detecting apparatus 24 comprises a camera for obtaining imaging information of the control signal in the camera via the optical unit; the computing apparatus 23 determines three-dimensional location information of the emitting apparatus with respect to the detecting apparatus based on the imaging information; the control apparatus 24 determines a control instruction corresponding to the three-dimensional location information so as to control the controlled device connected to the system. The emitting apparatus 21, detecting apparatus 22, and computing apparatus 23 are identical or substantially identical to the emitting apparatus 21, detecting apparatus 22, and computing apparatus 23 in the previous embodiment of FIG. 1, which will thus not be detailed here but incorporated here by reference. Here, the controlled device includes, but not limited to, one or more of TV, STB, mobile device, game machine, or PC. The connection between the control system and the controlled device may be wired, or wireless communication connection such as WiFi, infrared, Bluetooth, Zigbee, etc.

Specifically, the control apparatus 24 determine a corresponding control instruction based on the three-dimensional location information of the emitting apparatus 21 with respect to the detecting apparatus 22 as obtained by the computing apparatus 23, so as to control the controlled device connected to the control system. Preferably, the control apparatus 24 may determine a corresponding control instruction based on the three-dimensional location information in combination with control ancillary information transmitted by the emitting apparatus 21 and detected by the detecting apparatus 22, so as to control the controlled device connected to the control system.

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims, instead of the above depiction. Thus, all variations intended to fall into the meaning and scope of equivalent elements of the claims should be covered within the present invention. No reference signs in the claims should be regarded as limiting the involved claims. Besides, it is apparent that the term “comprise” does not exclude other units or steps, and singularity does not exclude plurality. A plurality of units or means stated in the apparatus claims may also be implemented by a single unit or means through software or hardware. Terms such as the first and the second are used to indicate names, but do not indicate any particular sequence.

1. A system for determining a three-dimensional location of an emitting apparatus with respect to a detecting apparatus, comprising:
an emitting apparatus comprising a light-emitting source for sending a control signal and an optical unit for facilitating transmitting the control signal;
a detecting apparatus comprising a camera, for obtaining imaging information of the control signal in the camera via the optical unit;
a computing apparatus for determining three-dimensional location information of the emitting apparatus with respect to the detecting apparatus according to the imaging information.

2. The system according to claim 1, wherein the computing apparatus comprises:
an input determining unit for performing image recognition processing to the imaging information so as to obtain an input light domain corresponding to the imaging information;
a feature extracting unit for extracting light domain feature information of the input light domain;
a location determining unit for determining the three-dimensional location information according to a mapping relationship between a light domain feature as actually measured and three-dimensional location information based on the light domain feature information.

3. The system according to claim 2, wherein the light domain feature information comprises at least one of the following items:
long axis information of the input light domain;
short axis information of the input light domain;
ratio information between a long axis and a short axis of the input light domain.

4. The system according to claim 2, wherein the feature extracting unit is for extracting light domain feature information of the input light domain, wherein the light domain feature information comprises light domain-related information between the input light domains.

5. The method according to claim 4, wherein the light domain-related information comprises at least one of the following items:
direction information of a connection line between centers of the input light domains;
distance information between the input light domains.

6. The system according to claim 2, wherein the three-dimensional location information comprises three-dimensional translational location information of the emitting apparatus with respect to the detecting apparatus;
wherein the location determining unit is configured to:
determine the three-dimensional translational location information based on the light domain feature information according to a mapping relationship between a light domain feature as actually measured and a distance of the emitting apparatus with respect to the detecting apparatus.

7. The system according to claim 2, wherein the three-dimensional location information comprises three-dimensional rotational location information of the emitting apparatus with respect to the detecting apparatus;
wherein the location determining unit is configured to:
determine the three-dimensional rotational location information according to a mapping relationship between a light domain feature as actually measured and an included angle of the emitting apparatus with respect to the detecting apparatus based on the light domain feature information.

8. The system according to claim 2, wherein the computing apparatus further comprises a noise cancelation unit configured to:
perform group processing according to a light emitting mode of the input light domains and/or distances between each two of the input light domains, so as to obtain one or more light domain sets, wherein each light domain set comprises one or more input light domains;
select a preferable light domain set from the one or more light domain sets according to set feature information of the light domain sets to act as a processing object of the feature extracting unit.

9. The system according to claim 1, wherein the system further comprises:
a location adjusting apparatus for adjusting the three-dimensional location information according to location reference information of the three-dimensional location information so as to obtain the adjusted three-dimensional location information.

10. The method according to claim 9, wherein the location adjusting apparatus is for adjusting the three-dimensional location information according to location reference information of the three-dimensional location information so as to obtain the adjusted three-dimensional location information, wherein the location reference information comprises historical location information corresponding to the three-dimensional location information.

11. The method according to claim 9, wherein the location adjusting apparatus is for adjusting the three-dimensional location information according to location reference information of the three-dimensional location information so as to obtain the adjusted three-dimensional location information, wherein the location reference information comprises three-dimensional location information in a frame relevant to the frame where the imaging information is located corresponding to the three-dimensional location information.

12. The system according to claim 9, wherein the system further comprises:
a location predicting apparatus for predicting predicted three-dimensional location information of the emitting apparatus with respect to the detecting apparatus according to historical three-dimensional location information of the emitting apparatus with respect to the detecting apparatus in combination with a predetermined motion model;
wherein the location adjusting apparatus is for adjusting the three-dimensional location information according to location reference information comprising the predicted three-dimensional location information so as to obtain the adjusted three-dimensional location information.

13. The system according to claim 1, wherein the optical unit comprises at least one of the following items:
a reflector disposed at a side face or rear end of the light-emitting source;
a light transmission body disposed at a front end of the light-emitting source.

14. The system according to claim 13, wherein the reflector has a convex reflecting face.

15. The system according to claim 13, wherein the light transmission body is inwardly concave towards the light-emitting source to form a flute.

16. The system according to claim 13, wherein the emitting apparatus comprises a plurality of light-emitting sources, at least one of the plurality of light-emitting sources is configured with at least one of the optical unit.

17. A system for remotely controlling a controlled device, wherein the system comprises:
an emitting apparatus comprising a light-emitting source for sending a control signal and an optical unit for facilitating transmitting the control signal;
a detecting apparatus comprising a camera, for obtaining imaging information of the control signal in the camera via the optical unit;
a computing apparatus for determining three-dimensional location information of the emitting apparatus with respect to the detecting apparatus based on the imaging information;
a control apparatus for determining a control instruction corresponding to the three-dimensional location information so as to control a controlled device connected to the system.

18. The system according to claim 17, wherein the controlled device comprises one or more of a TV, a set-top-box, a mobile device, a game machine, or PC.
